(19) United States
(12) Patent Application Publication
(10) Pub. No.: US 2025/0237621 A1
(43) Pub. Date: Jul. 24, 2025

(54) THIN FILM THICKNESS MEASURING DEVICE AND THIN FILM THICKNESS MEASURING METHOD

(71) Applicant: Samsung Display Co., LTD., Yongin-si (KR)

(72) Inventors: Won Hyuk JANG, Yongin-si (KR); Su Youn LEE, Yongin-si (KR); Hyo Seon LEE, Yongin-si (KR); Su A HAM, Yongin-si (KR)

(21) Appl. No.: 18/910,322

(22) Filed: Oct. 9, 2024

(30) Foreign Application Priority Data
Jan. 22, 2024 (KR) 10-2024-0009659

(51) Int. Cl. G01N 23/2252

(52) U.S. Cl. CPC G01N 23/2252; G01N 2223/079; G01N 2223/303; G01N 2223/61; G01N 2223/633

(57) ABSTRACT

A thin film thickness measuring device includes an electron beam generator which irradiates an electron beam onto a target object including a target thin film and a lower film below the target thin film, a detector which detects X-rays emitted from the target object, and a calculation unit which derives a thickness of the target thin film from an intensity of the detected X-rays and includes an X-ray intensity calculator which measures an X-ray intensity of a bulk sample of the target thin film or the lower film, measures an X-ray intensities of target thin films with known thicknesses or lower films below the target thin films with known thicknesses, and measures a third X-ray intensity of a target thin film with an unknown thickness or a lower film below the target thin film with an unknown thickness, a calibration ratio calculator, a calibration data storage, and a thickness calculator.

This application claims priority to Korean Patent Application No. 10-2024-0009659, filed on Jan. 22, 2024, and all the benefits accruing therefrom under 35 U.S.C. § 119, the content of which in its entirety is herein incorporated by reference.

### BACKGROUND

### 1. Field

The disclosure relates to a thin film thickness measuring device and a thin film thickness measuring method.

### 2. Description of the Related Art

With the advance of information-oriented society, more and more demands are placed on display devices for displaying images in various ways. The display device may be a display device such as a liquid crystal display, a field emission display and a light-emitting display. The light-emitting display may include an organic light-emitting display device including an organic light-emitting diode as a light-emitting element or an inorganic light-emitting display device including an inorganic light-emitting diode as a light-emitting element.

The display device includes various conductive films and non-conductive films, and the quality of the display device may vary depending on the thickness of the films, so accurately measuring the thickness of the films is an important factor.

### SUMMARY

Features of the disclosure provide a thin film thickness measuring device and a thin film thickness measuring method that may measure a thin film thickness in a non-destructive and non-contact manner without damaging a target object.

Features of the disclosure also provide a thin film thickness measuring device and a thin film thickness measuring method with improved process yield and process efficiency.

However, features of the disclosure are not restricted to those set forth herein. The above and other features of the disclosure will become more apparent to one of ordinary skill in the art to which the disclosure pertains by referencing the detailed description of the disclosure given below.

In an embodiment of the disclosure, there is provided a thin film thickness measuring device including, an electron beam generator which irradiates an electron beam onto a target object including a target thin film and a lower film disposed below the target thin film, a detector which detects X-rays emitted from the target object by the electron beam, and a calculation unit which derives a thickness of the target thin film from an intensity of the X-rays detected by the detector. The calculation unit includes, an X-ray intensity calculator which measures a first X-ray intensity of a bulk sample of the target thin film or a bulk sample of the lower film, measures second X-ray intensities of a plurality of target thin films with known thicknesses or a plurality of lower films disposed below the plurality of target thin films with the known thicknesses, and measures a third X-ray intensity of a target thin film with an unknown thickness or a lower film disposed below the target thin film with an unknown thickness, a calibration ratio calculator which calculates calibration ratios which are ratios of the second X-ray intensities to the first X-ray intensity, a calibration data storage which generates a calibration graph representing the calibration ratios against a thickness of the plurality of target thin films, and a thickness calculator which derives a thin film thickness corresponding to the third X-ray intensity from the calibration graph.

In an embodiment, the first X-ray intensity may be an X-ray intensity of the bulk sample of the target thin film, and the second X-ray intensities may be X-ray intensities of the plurality of target thin films with the known thicknesses.

In an embodiment, the first X-ray intensity may be an X-ray intensity of the bulk sample of the lower film, and the second X-ray intensities may be X-ray intensities of the plurality of lower films disposed below the plurality of target thin films with the known thicknesses.

In an embodiment, a calibration ratio when the first X-ray intensity is an X-ray intensity of the bulk sample of the target thin film, and the second X-ray intensities are X-ray intensities of the plurality of target thin films with the known thicknesses is a first calibration ratio, a calibration ratio when the first X-ray intensity is an X-ray intensity of the bulk sample of the lower film, and the second X-ray intensities are X-ray intensities of the plurality of lower films disposed below the plurality of target thin films with the known thicknesses is a second calibration ratio, the first calibration ratio and the second calibration ratio may be each less than or equal to 1, and a sum of the first calibration ratio and the second calibration ratio measured from the plurality of target thin films with the known thicknesses, having the same thickness, may be 1.

In an embodiment, the calibration graph may have a curved shape.

In an embodiment, the curve-shaped calibration graph may have a linear segment in part, and within the linear segment, the curve-shaped calibration graph may have an error range of ±5% in comparison to a calibration graph having a straight line shape.

In an embodiment, the calibration graph having the straight line shape may be a graph obtained by connecting both end points of the linear segment by a straight line.

In an embodiment, the linear segment may be a range corresponding to 10% to 90% of the calibration ratio.

In an embodiment, the thickness calculator may derive a thickness of the target thin film using the calibration graph having the straight line shape within the linear segment.

In an embodiment, a thickness of the plurality of target thin films with the known thicknesses may be less than or equal to a thickness of the bulk sample of the target thin film.

In an embodiment, a thickness of the bulk sample of the target thin film and a thickness of the bulk sample of the lower film may be greater than or equal to an analyzable depth of the electron beam generator.

In an embodiment, the target thin film may include a plurality of layers, and the plurality of layers may each include at least one different element.

In an embodiment, the target thin film may include at least one of a metal layer of a single element, an alloy layer, or an oxide conductive layer.

In an embodiment, the thin film thickness measuring device may further include a stage on which the target object may be placed. The target object and the stage may not be electrically connected.

In an embodiment, the target object may be a display device which is being manufactured or has been manufactured. The display device may include at least one conductive film, and a non-conductive film which insulates the at least one conductive film from an outside or other layers.

In an embodiment, the target thin film may be the conductive film, and the lower film may be the non-conductive film.

In an embodiment of the disclosure, there is provided a thin film thickness measuring device including, an electron beam generator which irradiates an electron beam onto a target object including a target thin film and a lower film disposed below the target thin film, a detector which detects X-rays emitted from the target object by the electron beam, and a calculation unit which derives a thickness of the target thin film from an intensity of the X-rays detected by the detector. The calculation unit includes, an X-ray intensity calculator which measures first X-ray intensities of a plurality of target thin films with known thicknesses, measures second X-ray intensities of a plurality of lower films disposed below the plurality of target thin films with the known thicknesses, and measures a third X-ray intensity of a target thin film with an unknown thickness, a calibration ratio calculator which calculates calibration ratios, which are ratios of the first X-ray intensities to the second X-ray intensities or ratios of the second X-ray intensities to the first X-ray intensities, a calibration data storage which generates a calibration graph representing the calibration ratios against a thickness of the plurality of target thin films, and a thickness calculator which derives a thin film thickness corresponding to the third X-ray intensity from the calibration graph.

In an embodiment, the calibration graph may have a straight line shape.

In an embodiment of the disclosure, there is provided a thin film thickness measuring method including, measuring a first X-ray intensity of a bulk sample of a target thin film or a bulk sample of a lower film disposed below the target thin film, measuring second X-ray intensities of a plurality of target thin films with known thicknesses or a plurality of lower films disposed below the target thin films with known thicknesses, calculating calibration ratios, which are ratios of the second X-ray intensities to the first X-ray intensity, to generate a calibration graph representing the calibration ratios against a thickness of the plurality of target thin films, and measuring a third X-ray intensity of a target thin film with an unknown thickness or a lower film disposed below the target thin film with an unknown thickness to derive a thin film thickness corresponding to the third X-ray intensity from the calibration graph.

In an embodiment of the disclosure, there is provided a thin film thickness measuring method including, measuring first X-ray intensities of a plurality of target thin films with known thicknesses, measuring second X-ray intensities of lower films disposed below the plurality of target thin films with the known thicknesses, calculating calibration ratios, which are ratios of the first X-ray intensities to the second X-ray intensities or ratios of the second X-ray intensities to the first X-ray intensities, to generate a calibration graph representing the calibration ratios against a thickness of the plurality of target thin films, and measuring a third X-ray intensity of a target thin film with an unknown thickness to derive a thin film thickness corresponding to the third X-ray intensity from the calibration graph.

In the thin film thickness measuring device and the thin film thickness measuring method according to the disclosure, the thin film thickness may be measured in a non-destructive and non-contact manner without damaging the target object.

In the thin film thickness measuring device and the thin film thickness measuring method according to the disclosure, process yield and process efficiency may be improved.

However, effects in the embodiments of the disclosure are not limited to those exemplified above and various other effects are incorporated herein.

### BRIEF DESCRIPTION OF THE DRAWINGS

The above and other advantages and features of the disclosure will become more apparent by describing in detail embodiments thereof with reference to the attached drawings, in which:

FIG. 1 is a plan view illustrating an embodiment of a display device;

FIG. 2 is a cross-sectional view taken along line X1-X1′ of FIG. 1;

FIG. 3A is an enlarged view of area A of FIG. 2;

FIG. 3B is a cross-sectional view illustrating an embodiment of a circuit layer CCL;

FIG. 4 is a cross-sectional view showing an embodiment of a thin film thickness measuring device;

FIG. 5 is a block diagram illustrating an embodiment of a calculation unit and a calculation process of the calculation unit;

FIG. 6 is a graph illustrating an embodiment of an EDX spectrum;

FIG. 7 is an enlarged view of area B of FIG. 6;

FIG. 8 is a cross-sectional view illustrating an embodiment of a method of measuring X-ray intensity of a bulk sample;

FIG. 9 is a cross-sectional view illustrating an embodiment of an emission type method of a thin film thickness measuring method;

FIG. 10 is a cross-sectional view illustrating an embodiment of an absorption type method of a thin film thickness measuring method;

FIG. 11 is a schematic graph illustrating an embodiment of a calibration curve;

FIG. 12 is a graph showing one embodiment of a calibration curve and a calibration straight line derived by an emission type method of a thin film thickness measuring method in an embodiment for each acceleration voltage of a thin film thickness measuring device;

FIG. 13 is a graph showing one embodiment of a calibration curve and a calibration straight line derived by an absorption type method of a thin film thickness measuring method for each acceleration voltage of a thin film thickness measuring device;

FIG. 14 is a cross-sectional view illustrating an embodiment of an element ratio type method of a thin film thickness measuring method;

FIG. 15 is a graph illustrating a calibration straight line derived by an embodiment of an element ratio type method of a thin film thickness measuring method;

FIG. 16 is a flowchart illustrating an embodiment of an emission type method of a thin film thickness measuring method;

FIG. 17 is a flowchart illustrating an embodiment of an absorption type method of a thin film thickness measuring method;

FIG. 18 is a flowchart illustrating an embodiment of an element ratio type method of a thin film thickness measuring method;

FIG. 19 illustrates a comparative embodiment of an X-ray intensity measurement graph;

FIG. 20 illustrates a calibration graph measured by an embodiment of an emission type method of a thin film thickness measuring method; and

FIG. 21 illustrates a calibration graph measured by an embodiment of an element ratio type method of a thin film thickness measuring method.

### DETAILED DESCRIPTION

Embodiments of the disclosure will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art.

It will also be understood that when a layer is referred to as being “on” another layer or substrate, it may be directly on the other layer or substrate, or intervening layers may also be present. The same reference numbers indicate the same components throughout the specification.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the disclosure will be described in detail with reference to the accompanying drawings.

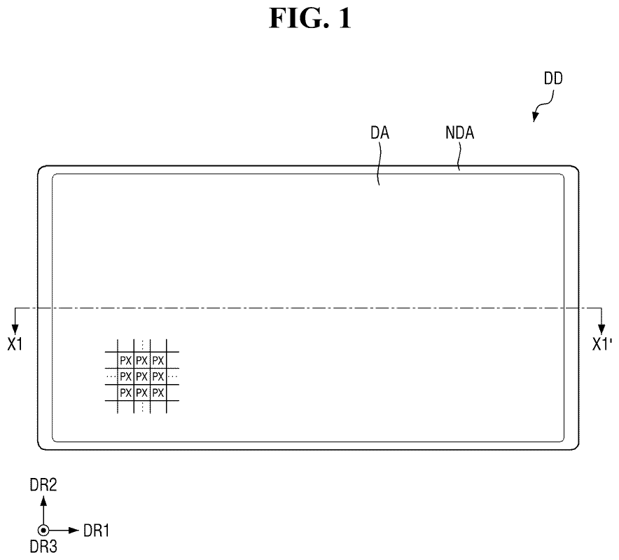

FIG. 1 is a plan view illustrating an embodiment of a display device.

Referring to FIG. 1, a display device DD may refer to any electronic device providing a display screen. The display device DD may display a moving image or a still image. In embodiments, the display device DD may include a television, a laptop computer, a monitor, a billboard, an Internet-of-Things device, a mobile phone, a smartphone, a tablet personal computer (“PC”), an electronic watch, a smart watch, a watch phone, a head-disposed (e.g., mounted) display, a mobile communication terminal, an electronic notebook, an electronic book, a portable multimedia player (“PMP”), a navigation device, a game machine, a digital camera, a camcorder or the like, which provide a display screen.

In an embodiment, the display device DD may have a quadrangular shape, e.g., rectangular shape in a plan view. The display device DD may include two long sides extending in a first direction DR1 and two short sides extending in a second direction DR2 intersecting the first direction DR1. A corner where the long side and the short side of the display device DD meet may have a right angle. However, the disclosure is not limited thereto, and the corner may have a curved surface. In another embodiment, the long side may extend in the second direction DR2, and the short side may extend in the first direction DR1. The planar shape of the display device DD is not limited to the exemplified one, but may have a circular shape or other shapes.

In the illustrated figure, the first direction DR1 and the second direction DR2 cross each other as horizontal directions. In an embodiment, the first direction DR1 and the second direction DR2 may be orthogonal to each other, for example. In addition, the third direction DR3 crosses the first direction DR1 and the second direction DR2, and may be perpendicular directions orthogonal to each other, for example. Unless otherwise defined, in the specification, directions indicated by arrows of the first to third directions DR1, DR2, and DR3 may be also referred to as one side, and the opposite directions thereto may be also referred to as an opposite side.

The display device DD may include a display panel which provides a display screen. In embodiments, the display panel may include an inorganic light-emitting diode display panel, an organic light-emitting display panel, a quantum dot light-emitting display panel, a plasma display panel and a field emission display panel. In the following description, a case where an organic light-emitting diode display panel is applied as a display panel will be exemplified, but the disclosure is not limited thereto, and other display panels may be applied within the same scope of technical spirit.

The display device DD may include a display area DA and a non-display area NDA disposed around the display area DA. The display area DA is an area where a screen is displayed, and the non-display area NDA is an area where a screen is not displayed. The display area DA may also be referred to as an active region, and the non-display area NDA may also be referred to as a non-active region. The display area DA substantially occupies the center of the display device DD, and the non-display area NDA may be disposed to surround the display area DA.

The display area DA may include a plurality of pixels PX. The plurality of pixels PX may be disposed in a matrix. The shape of each pixel PX may be a quadrangular shape, e.g., rectangular or square shape in a plan view. However, the disclosure is not limited thereto, and it may be a rhombic shape in which each side is inclined with respect to one direction.

As described above, the non-display area NDA may be disposed around the display area DA. The non-display area NDA may completely or partially surround the display area DA. The display area DA may have a quadrangular shape, e.g., rectangular shape, and the non-display area NDA may be disposed adjacent to four sides of the display area DA. The non-display area NDA may form a bezel of the display device DD. Wires or circuit drivers included in the display device DD may be disposed in the non-display area NDA, or external devices may be disposed (e.g., mounted) thereon.

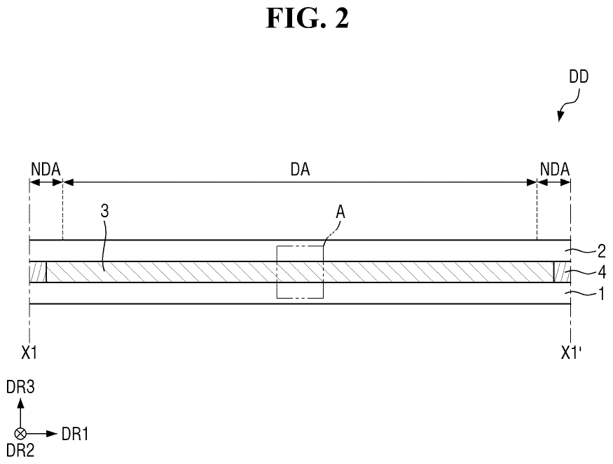

FIG. 2 is a cross-sectional view taken along line X1-X1′ of FIG. 1.

Referring to FIG. 2, the display device DD may include a display substrate 1, a color conversion substrate 2 facing the display substrate 1, a sealing portion 4 that bonds the display substrate 1 to the color conversion substrate 2, and a filler 3 filled between the display substrate 1 and the color conversion substrate 2.

The display substrate 1 may include elements and circuits for displaying an image, e.g., a pixel circuit such as a switching element, a self-light-emitting element, and a pixel defining layer defining an emission area and a non-emission area. In an embodiment, the self-light-emitting element may include a light-emitting diode (“LED”) including at least one of an organic light-emitting diode (“OLED”), a quantum dot LED, an inorganic micro LED, or an inorganic nano LED.

The color conversion substrate 2 may be disposed on the display substrate 1 to face the display substrate 1. In an embodiment, the color conversion substrate 2 may include a color conversion pattern for converting the color of incident light. In an embodiment, the color conversion pattern may include at least one of a color filter and a wavelength conversion pattern.

The sealing portion 4 may be disposed between the display substrate 1 and the color conversion substrate 2 in the non-display area NDA. The sealing portion 4 may be disposed along edges of the display substrate 1 and the color conversion substrate 2 in the non-display area NDA to surround the display area DA in a plan view. The display substrate 1 and the color conversion substrate 2 may be bonded to each other through the sealing portion 4.

The filler 3 may be disposed in a space between the display substrate 1 and the color conversion substrate 2 surrounded by the sealing portion 4. The filler 3 may fill the space between the display substrate 1 and the color conversion substrate 2. The filler 3 may include or consist of a material that may transmit light. In some embodiments, the filler 3 may be omitted.

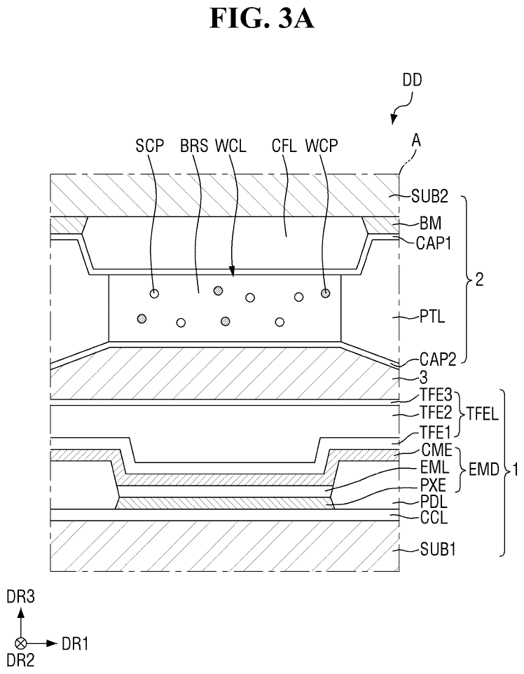

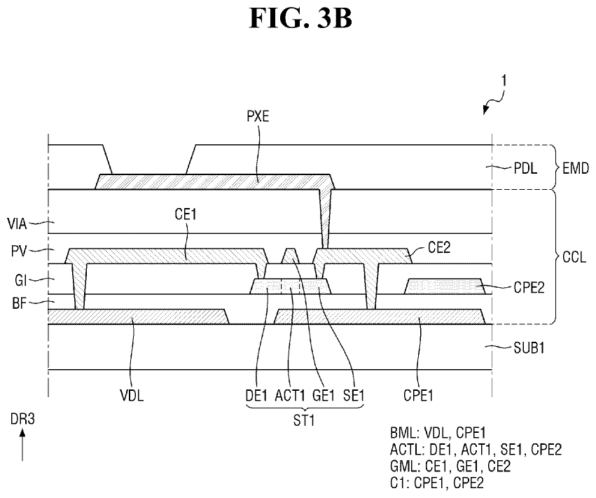

FIG. 3A is an enlarged view of area A of FIG. 2.

Referring to FIG. 3A, the display device DD may include the display substrate 1, the color conversion substrate 2 facing the display substrate 1, and the filler 3 filled between the display substrate 1 and the color conversion substrate 2.

The display substrate 1 may include a first base substrate SUB1, a circuit layer CCL, a pixel defining layer PDL, a light-emitting element EMD, and a thin film encapsulation layer TFEL.

The first base substrate SUB1 may include a transparent material. In an embodiment, the first base substrate SUB1 may include a transparent insulating material such as glass, quartz, or the like, for example. The first base substrate SUB1 may be a rigid substrate. However, the first base substrate SUB1 is not limited thereto. The first base substrate SUB1 may include plastic such as polyimide or the like, and may have a flexible property such that it may be twisted, bent, folded, or rolled.

The circuit layer CCL may be disposed on the first base substrate SUB1. The circuit layer CCL may include a transistor for driving the light-emitting element EMD and various circuit wires. The circuit layer CCL may be disposed between the first base substrate SUB1 and the light-emitting element EMD. The circuit layer CCL will be described later with reference to FIG. 3B.

The pixel defining layer PDL may be disposed on a pixel electrode PXE along the boundary of the pixel PX. The pixel defining layer PDL may define an opening that exposes at least a part of the pixel electrode PXE. The emission area and the non-emission area may be distinguished by the pixel defining layer PDL and the opening thereof.

The pixel defining layer PDL may include an organic insulating material such as acrylic resin, epoxy resin, phenolic resin, polyamide resin, polyimide resin, unsaturated polyester resin, polyphenylene resin, polyphenylenesulfide resin or benzocyclobutene (“BCB”). The pixel defining layer PDL may include an inorganic material.

The light-emitting element EMD may be disposed on the circuit layer CCL. Although one pixel PX is illustrated in FIG. 3A to show one light-emitting element EMD, the display substrate 1 may include a plurality of light-emitting elements EMD disposed for each pixel PX.

The light-emitting element EMD may include a pixel electrode PXE, a light-emitting layer EML, and a common electrode CME.

The pixel electrode PXE may be disposed on the circuit layer CCL of the display substrate 1. The pixel electrode PXE may be a first electrode (e.g., an anode electrode) of the light-emitting element EMD. The pixel electrode PXE may have a stacked structure formed by stacking a material layer having a relatively high work function, such as indium tin oxide (“ITO”), indium zinc oxide (“IZO”), zinc oxide (ZnO) and indium oxide (In₂O₃), and a reflective material layer such as silver (Ag), magnesium (Mg), aluminum (Al), platinum (Pt), lead (Pb), gold (Au), nickel (Ni), neodymium (Nd), iridium (Ir), chromium (Cr), lithium (Li), calcium (Ca), or any combinations thereof. The material layer having a relatively high work function may be disposed above the reflective material layer and disposed closer to the light-emitting layer EML. The pixel electrode PXE may have a multilayer structure such as ITO/Mg, ITO/MgF, ITO/Ag and ITO/Ag/ITO, but is not limited thereto.

The light-emitting layer EML may be disposed on the pixel electrode PXE exposed by the pixel defining layer PDL. In an embodiment in which the display device DD is an organic light-emitting display, the light-emitting layers EML may include an organic layer having an organic material. The organic layer may have an organic light-emitting layer, and in some cases, may further have at least one of a hole injection layer, a hole transport layer, an electron transport layer, or an electron injection layer as an auxiliary layer for light emission. In another embodiment, when the display device DD is a micro LED display device, a nano LED display device, or the like, the light-emitting layer EML may include an inorganic material such as an inorganic semiconductor.

In an embodiment, the wavelengths of light emitted from the respective light-emitting layers EML may be the same regardless of the pixels PX. In an embodiment, the light-emitting layer EML of each pixel PX may emit blue light or ultraviolet rays, and the color conversion substrate 2 which will be described later may include a wavelength conversion layer WCL, thereby displaying a color for each pixel PX, for example. In another embodiment, the wavelength of light emitted by each light-emitting layer EML may be different for each pixel PX.

The common electrode CME may be disposed on the light-emitting layer EML. The common electrode CME may be continuous across the pixels PX. The common electrode CME may be a full surface electrode disposed over the entirety of the surface across all the pixels PX. The common electrode CME may be a second electrode (e.g., a cathode electrode) of the light-emitting element EMD. The common electrode CME may include a material layer having a relatively low work function, such as Li, Ca, LiF/Ca, LiF/Al, Al, Mg, Ag, Pt, Pd, Ni, Au Nd, Ir, Cr, BaF, Ba or a compound or combination thereof (e.g., a combination of Ag and Mg). The common electrode CME may further include a transparent metal oxide layer disposed on the material layer having a relatively low work function.

The thin film encapsulation layer TFEL may be disposed on the common electrode CME. The thin film encapsulation layer TFEL may include a first inorganic layer TFE1, an organic layer TFE2, and a second inorganic layer TFE3.

The first inorganic layer TFE1 may be disposed on the light-emitting element EMD. The first inorganic layer TFE1 may include silicon nitride (SiNx), silicon oxide (SiOx), silicon oxynitride (SiOxNy), or the like.

The organic layer TFE2 may be disposed on the first inorganic layer TFE1. The organic layer TFE2 may include an organic insulating material selected from the group including acrylic resin, epoxy resin, phenolic resin, polyamide resin, polyimide resin, unsaturated polyester resin, polyphenylene ether resin, polyphenylenesulfide resin and benzocyclobutene (“BCB”).

The second inorganic layer TFE3 may be disposed on the organic layer TFE2. The second inorganic layer TFE3 may include the same material as that of the first inorganic layer TFE1 described above. In an embodiment, the second inorganic layer TFE3 may include silicon nitride (SiNx), silicon oxide (SiOx), silicon oxynitride (SiOxNy), or the like, for example.

The color conversion substrate 2 may be disposed to face the display substrate 1 above the thin film encapsulation layer TFEL. Specifically, the color conversion substrate 2 may be disposed to face the display substrate 1 with the filler 3 interposed therebetween.

The color conversion substrate 2 may include a second base substrate SUB2, a light-blocking member BM, a color filter layer CFL, a first capping layer CAP1, a partition wall PTL, the wavelength conversion layer WCL, and a second capping layer CAP2.

The second base substrate SUB2 may include a transparent material. In an embodiment, the second base substrate SUB2 may include a transparent insulating material such as glass, quartz, or the like, for example. The second base substrate SUB2 may be a rigid substrate. However, the second base substrate SUB2 is not limited thereto. The second base substrate SUB2 may include plastic such as polyimide or the like, and may have a flexible property such that it may be twisted, bent, folded, or rolled.

The second base substrate SUB2 may be the same substrate as the first base substrate SUB1, but may have a different material, thickness, transmittance or the like. In an embodiment, the second base substrate SUB2 may have a higher transmittance than the first base substrate SUB1, for example. The second base substrate SUB2 may be thicker or thinner than the first base substrate SUB1.

The light-blocking member BM may be disposed along the boundary of the pixel PX on one surface of the second base substrate SUB2 facing the first base substrate SUB1. The light-blocking member BM may overlap the pixel defining layer PDL of the display substrate 1. The light-blocking member BM may define an opening that exposes one surface of the second base substrate SUB2, and may be formed in a lattice shape in a plan view although not shown.

The light-blocking member BM may include an organic material. The light-blocking member BM may reduce color distortion due to external light reflection by absorbing the external light. Further, the light-blocking member BM may serve to prevent light which is emitted from the light-emitting layer EML from entering the adjacent pixels PX.

The color filter layer CFL may be disposed on one surface of the second base substrate SUB2 on which the light-blocking member BM is disposed. The color filter layer CFL may be disposed on one surface of the second base substrate SUB2 that is exposed through the opening of the light-blocking member BM.

The color filter layer CFL may include a colorant such as a dye or pigment that absorbs wavelengths other than the corresponding color wavelength. The color filter layer CFL may include colorants of different colors for each pixel PX. In an embodiment, the color filter layer CFL may include a red colorant, a green colorant, and a blue colorant, for example.

The first capping layer CAP1 may be disposed on the color filter layer CFL. The first capping layer CAP1 may prevent permeation of impurities such as moisture, air, or the like. Further, the first capping layer CAP1 may prevent the colorants of the color filter layers CFL from being diffused into other components.

The partition wall PTL may be disposed on the first capping layer CAP1. The partition wall PTL may be disposed to overlap the light-blocking member BM. The partition wall PTL may define an opening exposing a region in which the color filter layer CFL is disposed. The partition wall PTL may include a photosensitive organic material, but the disclosure is not limited thereto. The partition wall PTL may further include a light-blocking material.

The wavelength conversion layer WCL may be disposed in the space exposed by the opening of the partition wall PTL. The wavelength conversion layer WCL may convert the wavelength of light incident from the light-emitting layer EML. The wavelength conversion layer WCL may include a base resin BRS, and a scatterer SCP and a wavelength conversion material WCP disposed in the base resin BRS.

The base resin BRS may include or consist of a light-transmissive organic material. In an embodiment, the base resin BRS may include or consist of epoxy resin, acrylic resin, cardo resin, or imide resin, for example.

The wavelength conversion material WCP may be a material that converts a color. The wavelength conversion material WCP may be a quantum dot, a quantum rod, a phosphor, or the like. In embodiments, the quantum dot may include group IV nanocrystal, group II-VI compound nanocrystal, group III-V compound nanocrystal, group IV-VI nanocrystal, or any combinations thereof.

In another embodiment, the wavelength conversion layer WCL may not include the wavelength conversion material WCP. When the wavelength conversion layer WCL does not include the wavelength conversion material WCP, it may serve as a light-transmitting layer that transmits light.

The scatterer SCP may be a metal oxide particle or an organic particle. In embodiments, the metal oxide may include titanium oxide (TiO₂), zirconium oxide (ZrO₂), aluminum oxide (Al₂O₃), indium oxide (In₂O₃), zinc oxide (ZnO), tin oxide (SnO₂), or the like. In embodiments, a material of the organic particles may include acrylic resin and urethane resin, or the like.

The second capping layer CAP2 may be disposed on the wavelength conversion layer WCL and the partition wall PTL. The second capping layer CAP2 may be disposed on the entirety of the surface of the color conversion substrate 2. The second capping layer CAP2 may prevent permeation of impurities such as moisture, air, or the like. The second capping layer CAP2 may include or consist of an inorganic material. The second capping layer CAP2 may include a material selected from the above-mentioned materials of the first capping layer CAP1. The second capping layer CAP2 and the first capping layer CAP1 may include or consist of the same material as each other, but are not limited thereto.

The filler 3 may be disposed between the display substrate 1 and the color conversion substrate 2. The filler 3 may fill a space between the display substrate 1 and the color conversion substrate 2, and may serve to bond them to each other. The filler 3 may be disposed between the thin film encapsulation layer TFEL of the display substrate 1 and the second capping layer CAP2 of the color conversion substrate 2. The filler 3 may include or consist of an Si-based organic material, an epoxy-based organic material, or the like, but is not limited thereto.

FIG. 3B is a cross-sectional view illustrating an embodiment of the circuit layer CCL.

Referring to FIG. 3B, the display substrate 1 may include the first base substrate SUB 1, the circuit layer CCL, and the light-emitting element EMD.

Since the first base substrate SUB1 and the light-emitting element EMD has been described above with reference to FIG. 3A, the description will be omitted.

The circuit layer CCL may be disposed on the first base substrate SUB1. The circuit layer CCL (e.g., a thin film transistor layer) may include a lower conductive layer BML, a buffer layer BF, an active layer ACTL, a gate insulating layer GI, a gate conductive layer GML, a passivation layer PV, and a via layer VIA. The circuit layer CCL may include a first transistor ST1 and a capacitor C1.

The lower conductive layer BML may be disposed on the first base substrate SUB1. The lower conductive layer BML may include a single layer or multiple layers including or consisting of any one of molybdenum (Mo), aluminum (Al), chromium (Cr), gold (Au), titanium (Ti), nickel (Ni), neodymium (Nd) and copper (Cu) or any alloys thereof.

In an embodiment, the lower conductive layer BML may include a first voltage line VDL and a first capacitor electrode CPE1 of the capacitor C1.

The buffer layer BF may be disposed on the lower conductive layer BML. The buffer layer BF may include an inorganic material such as a silicon nitride layer, a silicon oxynitride layer, a silicon oxide layer, a titanium oxide layer and an aluminum oxide layer. In an alternative embodiment, the buffer layer BF may include a multilayer in which a plurality of layers selected from a silicon nitride layer, a silicon oxynitride layer, a silicon oxide layer, a titanium oxide layer and an aluminum oxide layer are alternately stacked.

The active layer ACTL may be disposed on the buffer layer BF. The active layer ACTL may include polycrystalline silicon, monocrystalline silicon, low-temperature polycrystalline silicon, amorphous silicon, or an oxide semiconductor material.

In an embodiment, the active layer ACTL may include a first active region ACT1, a first drain electrode DE1, and a first source electrode SE1 of the first transistor ST1, and a second capacitor electrode CPE2 of the capacitor C1.

The gate insulating layer GI may be disposed on the active layer ACTL. The gate insulating layer GI may include an inorganic layer, e.g., a silicon nitride layer, a silicon oxynitride layer, a silicon oxide layer, a titanium oxide layer, or an aluminum oxide layer.

The gate conductive layer GML may be disposed on the gate insulating layer GI. The gate conductive layer GML may include a single layer or multiple layers including or consisting of any one of molybdenum (Mo), aluminum (Al), chromium (Cr), gold (Au), titanium (Ti), nickel (Ni), neodymium (Nd) and copper (Cu) or any alloys thereof.

In an embodiment, the gate conductive layer GML may include a first gate electrode GE1 of the first transistor ST1, and connection electrodes CE1 and CE2.

The passivation layer PV may be disposed on the gate conductive layer GML. The passivation layer PV may include an inorganic layer, e.g., a silicon nitride layer, a silicon oxynitride layer, a silicon oxide layer, a titanium oxide layer, or an aluminum oxide layer.

The via layer VIA may be disposed on the passivation layer PV. The via layer VIA may include an organic layer such as an acryl resin, an epoxy resin, a phenolic resin, a polyamide resin, a polyimide resin, or the like.

The first transistor ST1 may include the first active region ACT1, the first gate electrode GE1, the first drain electrode DE1, and the first source electrode SE1.

The first active region ACT1 may be disposed in the active layer ACTL. The first gate electrode GE1 may be disposed in the gate conductive layer GML. The first drain electrode DE1 and the first source electrode SE1 may be formed by heat treating the active layer ACTL to make it conductive. The first drain electrode DE1 and the first source electrode SE1 may be made conductive as a P-type semiconductor or an N-type semiconductor, but are not limited thereto. The first drain electrode DE1 may be electrically connected to the first voltage line VDL to receive a driving voltage. The first source electrode SE1 may be connected to the light-emitting element EMD to supply a driving current to the light-emitting element EMD.

The capacitor C1 may include a first capacitor electrode CPE1 and a second capacitor electrode CPE2. The first capacitor electrode CPE1 may be disposed in the lower conductive layer BML. The second capacitor electrode CPE2 may be disposed in the active layer ACTL.

Hereinafter, a thin film thickness measuring device that may be used to measure the thickness of a thin film included in the display device will be described.

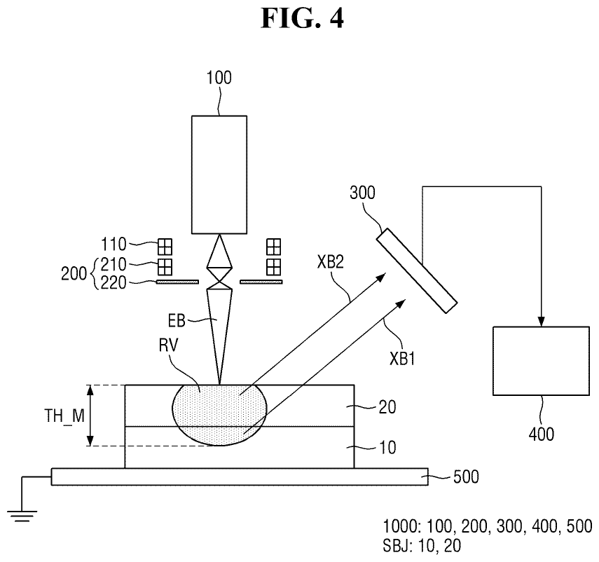

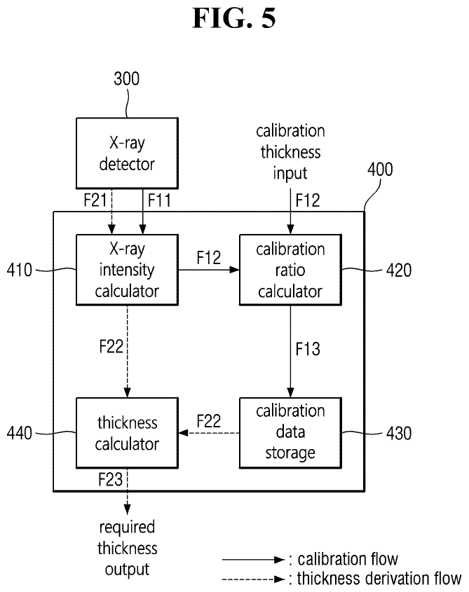

FIG. 4 is a cross-sectional view showing an embodiment of a thin film thickness measuring device. FIG. 5 is a block diagram illustrating an embodiment of a calculation unit and a calculation process of the calculation unit.

Referring to FIGS. 4 and 5, a thin film thickness measuring device 1000 in an embodiment may be an energy dispersive X-ray spectroscopic device (energy-dispersive X-ray spectroscopy (“EDX”) or energy-dispersive spectroscopy (“EDS”)). In an embodiment, the thin film thickness measuring device 1000 may be a device that irradiates an electron beam EB onto a target object SBJ, e.g., a thin film, and measures characteristic X-rays generated by the interaction between the electron beam EB and atoms contained in the target object SBJ, for example. The thin film thickness measuring device 1000 may measure the thickness of the thin film that is the target object SBJ by measuring the x-ray intensity generated from the target object SBJ.

The energy dispersive X-ray spectroscopic device may be used to analyze the composition and content of the target object SBJ. The thin film thickness measuring device 1000 in the illustrated embodiment may use the energy dispersive X-ray spectroscopic device to measure the thin film thickness of the target object SBJ.

The target object SBJ may include a lower film 10 and a target thin film 20. The target thin film 20 may be a thin film that is the subject of measurement by the thin film thickness measuring device 1000. The lower film 10 may be a film or layer disposed directly below the target thin film 20. In the drawing, the target thin film 20 is illustrated as being a single layer, but is not limited thereto. The target thin film 20 may have a stacked structure of a plurality of layers.

The target object SBJ may be a portion of the display device DD (refer to FIG. 1) described above with reference to FIGS. 1 to 3B. The target object SBJ may be the display device DD (refer to FIG. 1) that is being manufactured or has been manufactured.

In an embodiment, the lower film 10 of the target object SBJ may be the first base substrate SUB1 (refer to FIG. 3A) or the second base substrate SUB2 (refer to FIG. 3A) of the display device DD (refer to FIG. 1), and the target thin film 20 may be at least one of the upper films disposed on the first base substrate SUB1 (refer to FIG. 3A) or the second base substrate SUB2 (refer to FIG. 3A).

In another embodiment, the lower film 10 of the target object SBJ may be an insulating film of the first transistor ST1 (refer to FIG. 3B) described above, and the target thin film 20 may be the lower conductive layer BML (refer to FIG. 3B), the active layer ACTL (refer to FIG. 3B), and the gate conductive layer GML (refer to FIG. 3B).

In another embodiment, the lower film 10 of the target object SBJ may be an indium-tin-oxide (“ITO”) layer of the aforementioned pixel electrode PXE (refer to FIG. 3A), and the target thin film 20 may be a silver (Ag) layer.

In some embodiments, the target thin film 20 of the target object SBJ may include a metal layer of a single element such as copper (Cu), titanium (Ti), or silver (Ag), an alloy layer such as invar or stainless steel (SUS), and an oxide conductive layer such as indium-tin-oxide (“ITO”) or indium-gallium-zinc-oxide (“IGZO”).

The thin film thickness measuring device 1000 in an embodiment may include an electron beam generator 100, an optical module 200, an X-ray detector (e.g., X-ray sensor) 300, a calculation unit (e.g., calculation circuitry) 400, and a stage 500.

The electron beam generator 100 may generate the electron beam EB. The electron beam generator 100 may be a type of electron gun. In an embodiment, the electron beam generator 100 may be a thermionic electron gun or a field emission electron gun, for example. In an embodiment, when the electron beam generator 100 is a thermionic electron gun, the electron beam generator 100 may include a tungsten (W) filament or a LaB₆ filament. In another embodiment, when the electron beam generator 100 is a field emission electron gun, the electron beam generator 100 may include a cold field emission electron gun that operates without a filament.

The electron beam generator 100 may include an acceleration electrode (anode) 110 which accelerates the electron beam EB. The acceleration electrode 110 may generate acceleration voltages in various ranges. In an embodiment, an available acceleration voltage of the acceleration electrode 110 of the electron beam generator 100 may be approximately 1 kilovolt (kV) to 60 kV, for example, but is not limited thereto.

The electron beam EB may be accelerated by the acceleration voltage of the acceleration electrode 110 of the electron beam generator 100. A reaction volume RV, which is a region where the electron beam EB reacts with the target object SBJ, may vary depending on the magnitude of the acceleration voltage. In an embodiment, as the magnitude of the acceleration voltage increases, the size of the reaction volume RV may increase and an analyzable depth TH_M of the thin film thickness measuring device 1000 may increase. In another embodiment, as the magnitude of the acceleration voltage decreases, the size of the reaction volume RV may decrease and the analyzable depth TH_M of the thin film thickness measuring device 1000 may decrease.

In some embodiments, the reaction volume RV is a region where the electron beam EB and the target object SBJ interact, and may be a three-dimensional spatial region. The analyzable depth TH_M is the depth of the reaction volume RV in a thickness direction of the target object SBJ, and may mean a one-dimensional depth.

In some embodiments, the size of the reaction volume RV and the analyzable depth TH_M may vary depending on the type of elements contained in the target object SBJ as well as the acceleration voltage. In an embodiment, as the target object SBJ includes or consists of an element with a larger atomic weight or atomic number, the size of the reaction volume RV and the analyzable depth TH_M may decrease. In another embodiment, as the target object SBJ includes or consists of an element with a smaller atomic weight or atomic number, the size of the reaction volume RV and the analyzable depth TH_M may increase.

The analyzable depth TH_M may be approximately a few nanometers to a few micrometers. In an embodiment, in the case where the target thin film 20 is a metal layer including or consisting of aluminum (Al), the analyzable depth TH_M may be about 2.4 micrometers (μm) when the electron beam EB is irradiated at an acceleration voltage of 15 kiloelectronvolts (keV), the analyzable depth TH_M may be about 8.5 μm when the electron beam EB is irradiated at an acceleration voltage of 30 keV, the analyzable depth TH_M may be about 15.5 μm when the electron beam EB is irradiated at an acceleration voltage of 45 keV, and the analyzable depth TH_M may be about 24 μm when the electron beam EB is irradiated at an acceleration voltage of 60 keV.

In another embodiment, in the case where the target thin film 20 is a metal layer including or consisting of copper (Cu), the analyzable depth TH_M may be about 0.72 μm when the electron beam EB is irradiated at an acceleration voltage of 15 keV, the analyzable depth TH_M may be about 2.2 μm when the electron beam EB is irradiated at an acceleration voltage of 30 keV, the analyzable depth TH_M may be about 4.7 μm when the electron beam EB is irradiated at an acceleration voltage of 45 keV, and the analyzable depth TH_M may be about 8 μm when the electron beam EB is irradiated at an acceleration voltage of 60 keV.

In another example, in the case where the target thin film 20 is a metal layer including or consisting of silver (Ag), the analyzable depth TH_M may be about 0.65 μm when the electron beam EB is irradiated at an acceleration voltage of 15 keV, the analyzable depth TH_M may be about 2 μm when the electron beam EB is irradiated at an acceleration voltage of 30 keV, the analyzable depth TH_M may be about 3.35 μm when the electron beam EB is irradiated at an acceleration voltage of 45 keV, and the analyzable depth TH_M may be about 5.6 μm when the electron beam EB is irradiated at an acceleration voltage of 60 keV.

The analyzable depth TH_M depending on the acceleration voltage and element type is not limited to the above-mentioned values, and the analyzable depth TH_M may be varied depending on the distance from the electron beam generator 100 and other experimental conditions.

The electron beam EB may interact with the lower film 10 to generate a first X-ray XB1, and the electron beam EB may interact with the target thin film 20 to generate a second X-ray XB2.

The optical module 200 may control the path of the electron beam EB generated by the electron beam generator 100. The optical module 200 may include at least one lens 210 and at least one aperture 220.

In an embodiment, the lens 210 of the optical module 200 may include at least one of a condenser lens and a probe lens for controlling the convergence and divergence of the electron beam EB, an objective lens for determining the final size of the electron beam EB irradiated onto the target object SBJ, or a stigmator for correcting aberrations in the electron beam EB, for example. The aperture 220 of the optical module 200 may include at least one of an objective aperture or a condensing aperture for adjusting the amount, i.e., the intensity, of the electron beam EB.

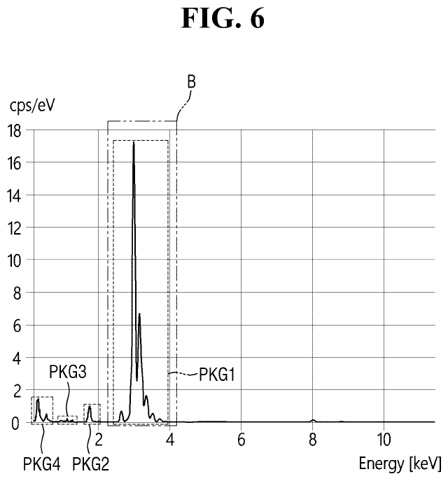

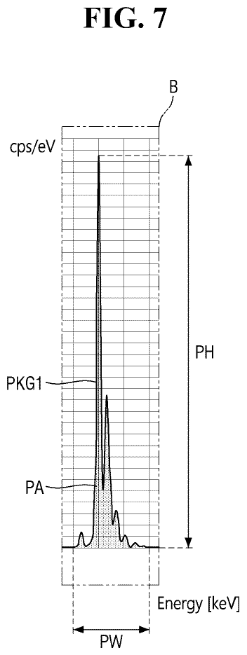

The X-ray detector 300 may detect characteristic X-rays generated by the target object SBJ interacting with the electron beam EB. The characteristic X-rays may have different energies depending on the type of elements contained in the target object SBJ. The X-ray detector 300 may generate an EDX spectrum based on the detected characteristic X-rays. The EDX spectrum will be described later with reference to FIGS. 6 and 7.

The calculation unit 400 may compare the X-ray intensity of a thin film with a known thickness to the X-ray intensity of a thin film with an unknown thickness to derive a desired thickness of the thin film with an unknown thickness. That is, the calculation unit 400 may compare the X-ray intensity of a thin film for which a thickness is known to the X-ray intensity of a thin film for which a thickness is unknown to derive a desired thickness of the thin film with an unknown thickness.

In an embodiment, as shown in FIG. 5, the calculation unit 400 may include an X-ray intensity calculator 410, a calibration ratio calculator 420, a calibration data storage 430, and a thickness calculator 440, for example.

The X-ray intensity calculator 410 may calculate or measure the X-ray intensity based on the EDX spectrum generated by the X-ray detector 300. An X-ray intensity calculation method of the X-ray intensity calculator 410 will be described later with reference to FIGS. 6 and 7.

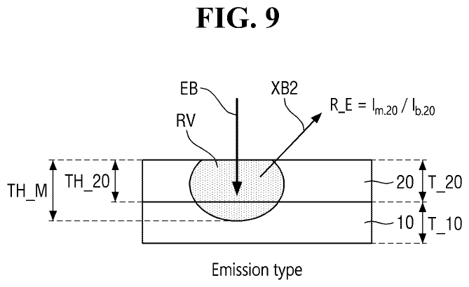

The calibration ratio calculator 420 may calculate a calibration ratio based on the X-ray intensity of the thin film with a known thickness measured by the X-ray intensity calculator 410 and calibration thickness information of the thin film with a known thickness. A calibration ratio calculation method of the calibration ratio calculator 420 will be described later with reference to FIGS. 9, 10, and 14.

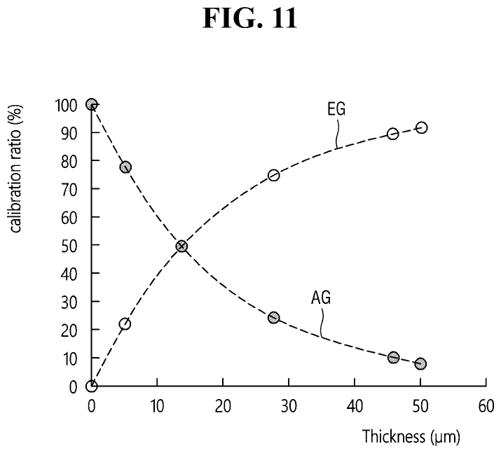

The calibration data storage 430 may generate and store calibration data based on calibration ratio information calculated by the calibration ratio calculator 420. The calibration data may include a calibration graph. The calibration graph may include a calibration curve and a calibration straight line. The calibration graph and a calibration data storage method of the calibration data storage 430 will be described later with reference to FIGS. 11 to 13 and 15.

The thickness calculator 440 may derive the desired thickness of the thin film with an unknown thickness by comparing the X-ray intensity of the thin film with an unknown thickness measured by the X-ray intensity calculator 410 to the X-ray intensity of the calibration data stored in the calibration data storage 430. The desired thickness derivation method of the thickness calculator 440 will be described later with reference to FIGS. 11 to 13 and 15.

The stage 500 may provide a space on which the target object SBJ may be placed. In some embodiments, the stage 500 may be grounded. In some embodiments, the stage 500 may be electrically connected to the target object SBJ.

When the stage 500 is electrically connected to the target object SBJ in a grounded state, the accumulation of electrons on the surface of the target object SBJ caused by the electron beam EB may be prevented. Accordingly, X-ray detection accuracy may be improved.

However, the disclosure is not limited thereto, and the stage 500 may not be grounded, and the stage 500 may not be electrically connected to the target object SBJ. In an embodiment, when the target object SBJ is a metallic thin film with relatively high electrical conductivity, the accumulation of electrons may be relatively weak, for example. Therefore, the stage 500 may not be grounded, and the stage 500 may not be electrically connected to the target object SBJ.

In some embodiments, the target object SBJ may include a conductive film on the surface of the target object SBJ. In an embodiment, the conductive film on the target object SBJ may be a metallic thin film, for example. The conductive film may be formed by electrical pretreatment. In an embodiment, the conductive film may be formed by metal pretreatment, for example. By including the conductive film through pretreatment, the target object SBJ may have improved electrical conductivity, thereby improving its interaction with the electron beam EB. In addition, the accumulation of electrons on the surface of the target object SBJ caused by the electron beam EB may be prevented. However, the disclosure is not limited thereto, and the target object SBJ may not be pretreated, and may not include the conductive film on the surface thereof.

The thin film thickness measuring device 1000 in the illustrated embodiment may measure the thickness of the thin film in a non-destructive and non-contact manner without damaging the target object SBJ. Therefore, it is possible to measure the thickness of an actual pattern of the display device DD (refer to FIG. 1) in actual mass production, and thus the accuracy of the thickness measurement may be improved.

In addition, since the thin film thickness measuring device 1000 in the illustrated embodiment is performed in a non-destructive and non-contact manner, it is possible to continue a post-process after measuring the thickness of the display device DD (refer to FIG. 1) in actual mass production, thereby improving process yield and process efficiency.

In addition, the analyzable depth TH_M of the thin film thickness measuring device 1000 in the illustrated embodiment may be within a few micrometers and have relatively high measurable resolution, so that the thickness of a fine pattern may be analyzed.

FIG. 6 is a graph illustrating an embodiment of an EDX spectrum. FIG. 7 is an enlarged view of area B of FIG. 6.

Referring to FIGS. 6 and 7 in addition to FIGS. 4 and 5, the X-ray detector 300 may detect the characteristic X-rays generated by the target object SBJ interacting with the electron beam EB. The characteristic x-rays may have different energies depending on the type of elements contained in the target object SBJ. The X-ray detector 300 may generate the EDX spectrum based on the detected characteristic X-rays.

The EDX spectrum is a graph showing the distribution of X-rays generated by the target object SBJ interacting with the electron beam EB. The EDX spectrum is a graph that divides X-rays based on predetermined energies (x-axis) and plots the intensity (y-axis) of X-ray signals at each energy. The x-axis of the EDX spectrum distinguishes X-rays by energy, while the y-axis indicates the number of times (counts per second (cps)) X-rays of each energy were detected divided by the energy (cps/electronvolt (eV)).

In an embodiment, as shown in FIG. 6, when the target object SBJ consists of four elements, there may be four peak groups of the characteristic X-rays, for example. The EDX spectrum shown in FIG. 6 may include a first peak group PKG1, a second peak group PKG2, a third peak group PKG3, and a fourth peak group PKG4.

The first to fourth peak groups PKG1, PKG2, PKG3, and PKG4 may represent peaks of characteristic X-rays generated from different elements. In an embodiment, the first peak group PKG1 may represent the peaks of characteristic X-rays generated from element A, the second peak group PKG2 from element B, the third peak group PKG3 from element C, and the fourth peak group PKG4 from element D, for example.

The X-ray intensity calculator 410 may calculate or measure the X-ray intensity based on the EDX spectrum generated by the X-ray detector 300. The X-ray intensity may be calculated or measured by an integral value of the peak group in the EDX spectrum (operation F11 in FIG. 5).

In an embodiment, as shown in FIG. 7, each peak in the first peak group PKG1 may have a peak height PH and a peak width PW, for example. A peak area PA of the first peak group PKG1 may be calculated using the peak height PH and the peak width PW of each peak. The peak area PA of the first peak group PKG1 may be the area size of the lower portion of the graph calculated by integrating the graph of the EDX spectrum. The X-ray intensity calculated or measured by the X-ray intensity calculator 410 may refer to the peak area PA.

When the target thin film 20 has a stacked structure of a plurality of layers, each layer included in the target thin film 20 may include at least one different constituent element. In an embodiment, when the target thin film 20 consists of three layers, and a first layer consists of elements a, b, and c, a second layer consists of elements a, b, and d, and a third layer consists of elements a, b, and e, the thin film thickness of each of the first to third layers may be measured by measuring the intensity of characteristic X-rays generated from the c element in the first layer, the d element in the second layer, and the e element in the third layer, for example.

The peak group of the EDX spectrum generated from the a and b elements contained in the first to third layers may not be distinguishable within a single peak group. The peak groups of the EDX spectrum generated from different constituent elements in the first to third layers, i.e., the c element in the first layer, the d element in the second layer, and the e element in the third layer, may exist in different energy ranges. Therefore, by measuring the intensity of the characteristic X-rays generated from each of the c element in the first layer, the d element in the second layer, and the e element in the third layer, the thin film thickness of each of the first to third layers may be measured.

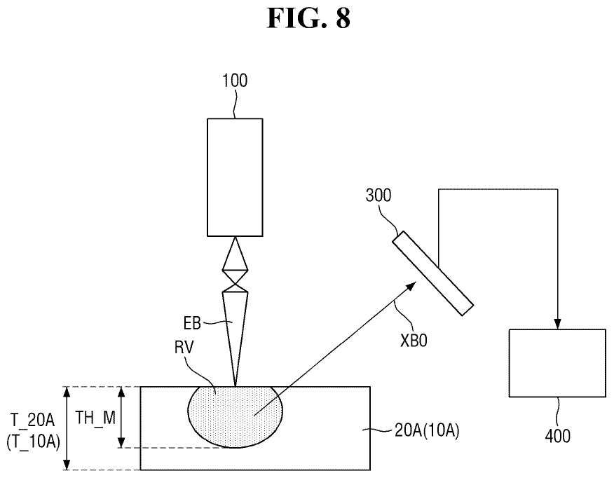

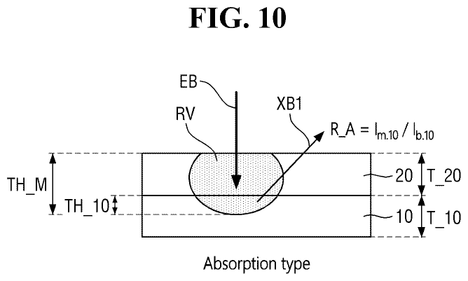

FIG. 8 is a cross-sectional view illustrating an embodiment of a method of measuring X-ray intensity of a bulk sample. FIG. 9 is a cross-sectional view illustrating an embodiment of an emission type method of a thin film thickness measuring method. FIG. 10 is a cross-sectional view illustrating an embodiment of an absorption type method of a thin film thickness measuring method. FIG. 11 is a schematic graph illustrating an embodiment of a calibration curve.

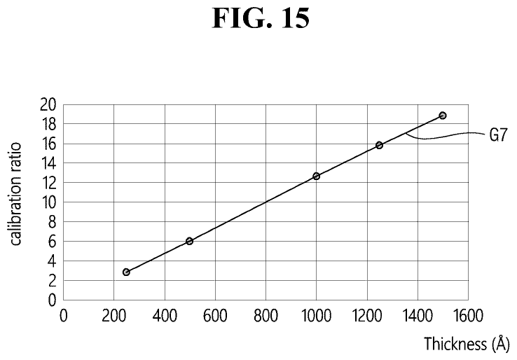

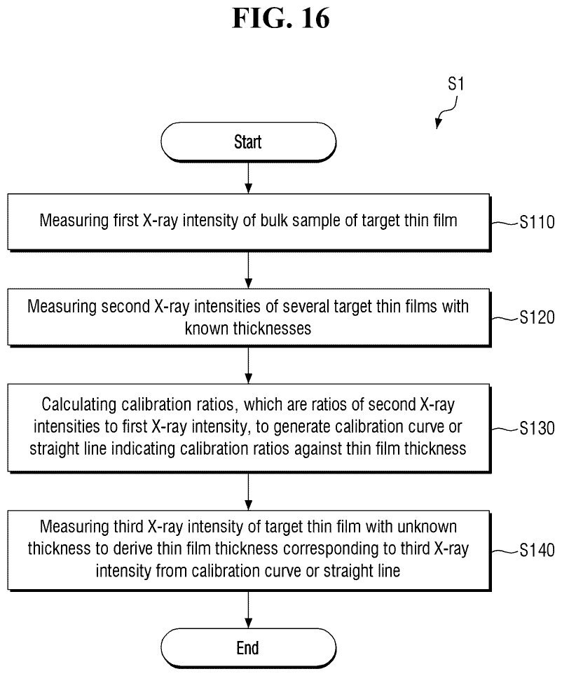

Referring to FIGS. 8 to 11 in addition to FIGS. 4 to 7, the thin film thickness measuring method in an embodiment may include an emission type method, an absorption type method, and an element ratio type method. Hereinafter, the emission type method and the absorption type method will be described first with reference to FIGS. 9 to 14, and the element ratio type method will be described with reference to FIGS. 15 and 16.

The calibration ratio calculator 420 may calculate the calibration ratio based on the X-ray intensity of the thin film with a known thickness measured by the X-ray intensity calculator 410 and the calibration thickness information of the thin film with a known thickness (operation F12 in FIG. 5).

As shown in FIG. 9, a calibration ratio R_E of the emission type method may be a ratio of an X-ray intensity I_{m.20} of a measuring sample of the target thin film 20 to an X-ray intensity I_{b.20} of a bulk sample 20A of the target thin film 20.

As shown in FIG. 10, a calibration ratio R_A of the absorption type method may be a ratio of an X-ray intensity I_{m.10} of a measuring sample of the lower film 10 to an X-ray intensity I_{b.10} of a bulk sample 10A of the lower film 10.

The bulk samples 10A and 20A refer to thick film samples consisting of the same element as the target thin film 20. In an embodiment, when the target thin film 20 is a silver (Ag) thin film with a thickness of 0.5 μm, the bulk sample 20A of the target thin film 20 may be a silver (Ag) thin film with a thickness greater than or equal to 0.5 μm. In another embodiment, when the lower film 10 is a glass (SiO₂) thin film with a thickness of 1 μm, the bulk sample 10A of the lower film 10 may be a glass (SiO₂) thin film with a thickness greater than or equal to 1 μm.

Thicknesses T_10A and T_20A of the bulk samples 10A and 20A may be substantially greater than a thickness T_10 of the lower film 10 and a thickness T_20 of the target thin film 20, but in some cases they may be the same.

First, in order to calculate the calibration ratio R_E of the emission type method and the calibration ratio R_A of the absorption type method, as shown in FIG. 8, the X-ray intensity calculator 410 may measure the X-ray intensities I_{b.10} and I_{b.20} of the bulk samples 10A and 20A (operation F11 in FIG. 5).

The thicknesses T_10A and T_20A of the bulk samples 10A and 20A may be greater than or equal to the analyzable depth TH_M of the thin film thickness measuring device 1000. In an embodiment, a minimum value of the thicknesses T_10A and T_20A of the bulk samples 10A and 20A may be equal to a maximum value of the analyzable depth TH_M, for example. When the thicknesses T_10A and T_20A of the bulk samples 10A and 20A are greater than or equal to the analyzable depth TH_M of the thin film thickness measuring device 1000, X-rays may be generated only in a range equal to the analyzable depth TH_M of the thin film thickness measuring device 1000, regardless of the thicknesses T_10A and T_20A of the bulk samples 10A and 20A. The electron beam EB may interact with the bulk samples 10A and 20A to generate a reference X-ray XB0.

When the acceleration voltage of the thin film thickness measuring device 1000, the type of elements contained in the bulk samples 10A and 20A, or the like are the same so that the analyzable depth TH_M is constant, the X-ray intensity of the reference X-ray XB0 may be constant. Therefore, the X-ray intensity calculator 410 may measure the X-ray intensity of the reference X-ray XB0 to calculate or measure the X-ray intensities I_{b.10} and I_{b.20} of the bulk samples 10A and 20A of a constant size.

Next, in order to calculate the calibration ratio R_E of the emission type method and the calibration ratio R_A of the absorption type method, as shown in FIGS. 9 and 10, the X-ray intensity calculator 410 may measure the X-ray intensity I_{m.10} of the measuring sample of the lower film 10 disposed below the target thin film 20 with a known thickness, and the X-ray intensity I_{m.20} of the measuring sample of the target thin film 20 with a known thickness (operation F11 in FIG. 5).

The measuring sample may be a sample of a plurality of target thin films 20 with known thicknesses. The thickness T_20 of the target thin film 20 as the measuring sample may be less than the analyzable depth TH_M. In this case, the reaction volume RV may be formed across the target thin film 20 and the lower film 10. A portion of the energy of the electron beam EB may interact with the target thin film 20 to generate the second X-ray XB2, and the remaining portion thereof may interact with the lower film 10 to generate the first X-ray XB1.

The emission type method may measure the X-ray intensity I_{m.20} of the measuring sample of the target thin film 20 by the second X-ray XB2 generated from the target thin film 20, and the absorption type method may measure the X-ray intensity I_{m.10} of the measuring sample of the lower film 10 by the first X-ray XB1 generated from the lower film 10.

Next, the calibration ratio calculator 420 may calculate the calibration ratio R_E of the emission type method and/or the calibration ratio R_A of the absorption type method for each calibration thickness of the thin film with a known thickness (operation F12 in FIG. 5).

As described above, the calibration ratio R_E of the emission type method may be a ratio of the X-ray intensity I_{m.20} of the measuring sample of the target thin film 20 to the X-ray intensity I_{b.20} of the bulk sample 20A of the target thin film 20. The calibration ratio R_A of the absorption type method may be a ratio of the X-ray intensity I_{m.10} of the measuring sample of the lower film 10 to the X-ray intensity I_{b.10} of the bulk sample 10A of the lower film 10.

In an embodiment, when the thickness T_20 of the target thin film 20 is 15 μm, the calibration ratio R_E of the emission type method and the calibration ratio R_A of the absorption type method may each be 50%. In another embodiment, when the thickness T_20 of the target thin film 20 is 28 μm, the calibration ratio R_E of the emission type method and the calibration ratio R_A of the absorption type method may be 70% and 30%, respectively.

In the above manner, the calibration ratio R_E of the emission type method and the calibration ratio R_A of the absorption type method may each be calculated or measured for each thickness T_20 of the target thin film 20 by a plurality of measuring samples having known and different thicknesses of the target thin film 20. In other words, the calibration thickness information of the measuring sample with a known thickness may be received from the outside, and combined with the calibration ratio information measured at the calibration thickness of the corresponding measuring sample to generate the calibration ratio information at a predetermined thickness (operation F12 in FIG. 5).

Next, the calibration data storage 430 may generate and store the calibration data based on the calibration ratio information at the predetermined thickness calculated by the calibration ratio calculator 420 (operation F13 in FIG. 5).

The calibration data may include a calibration graph. The calibration graph may include a calibration curve and a calibration straight line.

FIG. 11 shows the calibration curve, which is a graph of the calibration ratio against the thickness T_20 of the target thin film 20 measured using each of the emission type method and the absorption type method. In the graph of FIG. 11, the x-axis represents the thickness T_20 of the target thin film 20, and the y-axis represents the calibration ratios R_E and R_A, expressed as percentages. An emission type graph EG shows that the calibration ratio increases as the thickness T_20 of the target thin film 20 increases, and an absorption type graph AG shows that the calibration ratio decreases as the thickness T_20 of the target thin film 20 increases.

The calibration data, i.e., the calibration graph, generated by the calibration data storage 430 may be generated using the calibration ratio information for each thickness of the target thin film 20 of a plurality of samples measured by the calibration ratio calculator 420.

As shown in FIG. 11, the calibration ratio R_E of the emission type method and the calibration ratio R_A of the absorption type method may be inversely proportional to each other. In an embodiment, as the thickness T_20 of the target thin film 20 increases, a measuring depth TH_20 for the target thin film 20 may also increase, leading to an increase in the X-ray intensity of the second X-ray XB2. Since the analyzable depth TH_M is constant, a measuring depth TH_10 for the lower film 10 may decrease, and thus the X-ray intensity of the first X-ray XB1 may decrease in inverse proportion. In another embodiment, as the thickness T_20 of the target thin film 20 decreases, the measuring depth TH_20 for the target thin film 20 may also decrease, leading to a decrease in the X-ray intensity of the second X-ray XB2. Since the analyzable depth TH_M is constant, the measuring depth TH_10 for the lower film 10 may increase, and thus the X-ray intensity of the first X-ray XB1 may increase in inverse proportion.

In some embodiments, the sum of the calibration ratio R_E of the emission type method and the calibration ratio R_A of the absorption type method measured using the target thin film 20 having the same thickness may be 1. The calibration ratio R_E of the emission type method and the calibration ratio R_A of the absorption type method may each be less than or equal to 1. When expressed as a percentage, the sum of the calibration ratio R_E of the emission type method and the calibration ratio R_A of the absorption type method measured using the target thin film 20 having the same thickness may be 100%.

Finally, the thickness calculator 440 may derive the desired thickness of the thin film with an unknown thickness by comparing the X-ray intensity of the thin film with an unknown thickness measured by the X-ray intensity calculator 410 to the X-ray intensity of the calibration data stored in the calibration data storage 430.

In an embodiment, the X-ray intensity calculator 410 may measure the X-ray intensity of the target thin film 20 with an unknown thickness or the X-ray intensity of the lower film 10 below the target thin film 20 (operation F21 in FIG. 5), for example.

The thickness calculator 440 may derive the desired thickness of the thin film corresponding to the above X-ray intensity measured in the calibration graph of the emission type method or the absorption type method (operation F22 in FIG. 5).

The thickness calculator 440 may output the derived thin film thickness information to the outside (operation F23 in FIG. 5).

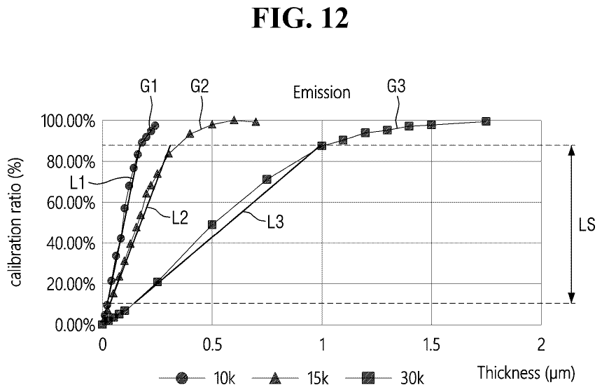

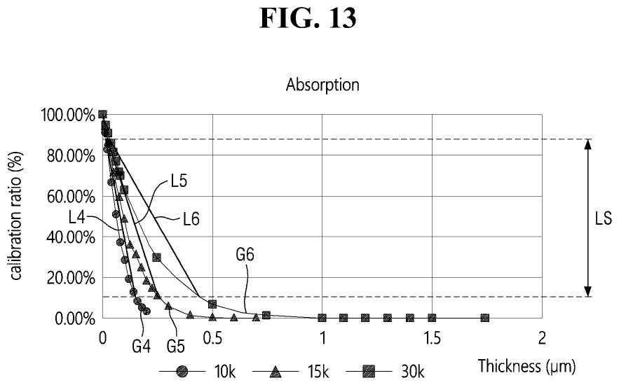

FIG. 12 is a graph showing a calibration curve and a calibration straight line derived by an embodiment of an emission type method of a thin film thickness measuring method for each acceleration voltage of a thin film thickness measuring device. FIG. 13 is a graph showing a calibration curve and a calibration straight line derived by an embodiment of an absorption type method of a thin film thickness measuring method for each acceleration voltage of a thin film thickness measuring device.

Referring to FIGS. 12 and 13 in addition to FIGS. 4 to 11, the graphs in FIGS. 12 and 13 are calibration graphs measured when the lower film 10 includes or consists of glass (SiO₂) and the target thin film 20 includes or consists of copper (Cu). First to sixth graphs G1, G2, G3, G4, G5, and G6 are calibration curves, and first to sixth straight lines L1, L2, L3, L4, L5, and L6 are calibration straight lines.

The first graph G1 and the fourth graph G4 are the calibration curves measured at an acceleration voltage of 10 keV, the second graph G2 and the fifth graph G5 at an acceleration voltage of 15 keV, and the third graph G3 and the sixth graph G6 at an acceleration voltage of 30 keV.

When comparing the first to third graphs G1, G2, and G3 or the fourth to sixth graphs G4, G5, and G6, it may be observed that the measurable maximum thickness becomes greater as the acceleration voltage becomes greater. The measurable maximum thickness may be the same as the analyzable depth TH_M described above.

In some embodiments, the first to sixth graphs G1, G2, G3, G4, G5, and G6 may include a linear segment LS. The linear segment LS refers to a segment of the calibration curve that exhibits a shape similar to a straight line graph within an error range. In an embodiment, within the linear segment LS, the first to sixth graphs G1, G2, G3, G4, G5, and G6 may exhibit a shape similar to the first to sixth straight lines L1, L2, L3, L4, L5, and L6, for example. In some embodiments, the straight line graph may be a graph obtained by connecting the end points of the linear segment LS by a straight line, and the error range may be within ±5%. In an embodiment, the linear segment LS may range from 10% to 90% of the calibration ratio.

In some embodiments, the thickness calculator 440 may use the calibration curve to derive the desired thickness of the thin film with an unknown thickness, but is not limited thereto. In an embodiment, when the calibration ratio measured in the thin film with an unknown thickness is disposed in the linear segment LS, the thickness calculator 440 may convert the calibration curve to the calibration straight line, and use the calibration straight line to derive the desired thickness, for example.

Hereinafter, the element ratio type method will be described. The same configurations as those described above for the emission type method and the absorption type method will be referred to by the same reference sign, redundant descriptions will be omitted or simplified, and differences will be primarily described.

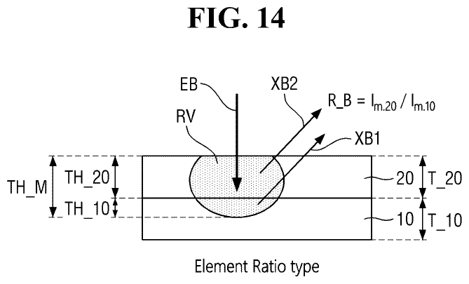

FIG. 14 is a cross-sectional view illustrating an embodiment of an element ratio type method of a thin film thickness measuring method. FIG. 15 is a graph illustrating a calibration straight line derived by an embodiment of an element ratio type method of a thin film thickness measuring method.

Referring to FIGS. 14 and 15 in addition to FIGS. 4 to 7, the calibration ratio calculator 420 may calculate the calibration ratio based on the X-ray intensity of the thin film with a known thickness measured by the X-ray intensity calculator 410 and the calibration thickness information of the thin film with a known thickness (operation F12 in FIG. 5).

As shown in FIG. 14, a calibration ratio R_B of the element ratio type method may be a ratio of the X-ray intensity I_{m.20} of the measuring sample of the target thin film 20 to the X-ray intensity I_{m.10} of the measuring sample of the lower film 10. In another embodiment, the calibration ratio R_B of the element ratio type method may be a ratio of the X-ray intensity I_{m.10} of the measuring sample of the lower film 10 to the X-ray intensity I_{m.20} of the measuring sample of the target thin film 20. Hereinafter, the former will be described by way of example.

First, in order to calculate the calibration ratio R_B of the element ratio type method, as shown in FIG. 14, the X-ray intensity calculator 410 may measure the X-ray intensities I_{m.10} and I_{m.20} of the measuring samples of the lower film 10 and the target thin film 20 (operation F11 in FIG. 5).

Next, the calibration ratio calculator 420 may calculate the calibration ratio R_B of the element ratio type method for each calibration thickness of the thin film with a known thickness (operation F12 in FIG. 5).

In an embodiment, when the thickness T_20 of the target thin film 20 is 500 angstrom (Å), the calibration ratio R_B of the element ratio type method may be approximately 6. In another embodiment, when the thickness T_20 of the target thin film 20 is 1000 Å, the calibration ratio R_E of the emission type method and the calibration ratio R_A of the absorption type method may be approximately 13.

In the above manner, the calibration ratio R_B of the element ratio type method may be calculated or measured for each thickness T_20 of the target thin film 20 by a plurality of measuring samples with known and different thicknesses of the target thin film 20. In other words, the calibration thickness information of the measuring sample with a known thickness may be received from the outside, and combined with the calibration ratio information measured at the calibration thickness of the corresponding measuring sample to generate the calibration ratio information at a predetermined thickness (operation F12 in FIG. 5).

Next, the calibration data storage 430 may generate and store the calibration data based on the calibration ratio information at the predetermined thickness calculated by the calibration ratio calculator 420 (operation F13 in FIG. 5).

FIG. 15 shows the calibration straight line, which is a graph of the calibration ratio against the thickness T_20 of the target thin film 20 measured using the element ratio type method. In the graph of FIG. 15, the x-axis represents the thickness T_20 of the target thin film 20, and the y-axis represents the calibration ratio.

When the calibration ratio R_B of the element ratio type method is a ratio of the X-ray intensity I_{m.20} of the measuring sample of the target thin film 20 to the X-ray intensity I_{m.10} of the measuring sample of the lower film 10, the element ratio type graph shows that the calibration ratio R_B of the element ratio type method increases as the thickness T_20 of the target thin film 20 increases.

In another embodiment, when the calibration ratio R_B of the element ratio type method is a ratio of the X-ray intensity I_{m.10} of the measuring sample of the lower film 10 to the X-ray intensity I_{m.20} of the measuring sample of the target thin film 20, the element ratio type graph may show that the calibration ratio R_B of the element ratio type method decreases as the thickness T_20 of the target thin film 20 increases.

The graph of FIG. 15 shows the calibration straight line measured when the lower film 10 includes or consists of indium-tin-oxide (“ITO”) and the target thin film 20 includes or consists of silver (Ag). A seventh graph G7 in FIG. 15 represents a calibration straight line measured for the case where the acceleration voltage is 15 keV.

In the case of the element ratio type method, the calibration straight line appears as a straight line rather than a curve, so the thickness calculator 440 may derive the desired thickness of the thin film in all ranges without the error range and the constraints of the linear segment LS.

Hereinafter, the thin film thickness measuring method in an embodiment will be described.

FIG. 16 is a flowchart illustrating an embodiment of an emission type method of a thin film thickness measuring method.

Referring to FIG. 16, an emission type method S1 of the thin film thickness measuring method in an embodiment may include measuring a first X-ray intensity of a bulk sample of the target thin film (operation S110), measuring second X-ray intensities of a plurality of target thin films with known thicknesses (operation S120), calculating calibration ratios, which are ratios of the second X-ray intensities to the first X-ray intensity, to generate the calibration curve or straight line indicating the variation of the calibration ratios against the thin film thickness (operation S130), and measuring a third X-ray intensity of the target thin film with an unknown thickness to derive the thin film thickness corresponding to the third X-ray intensity from the calibration curve or straight line (operation S140).

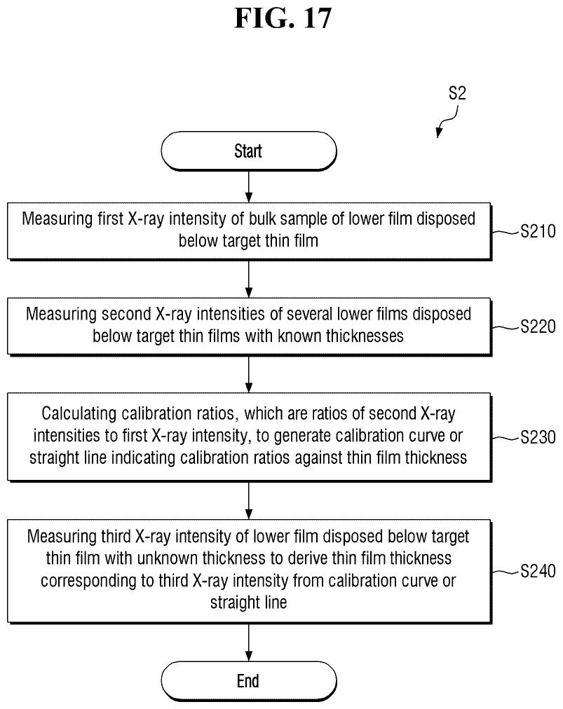

FIG. 17 is a flowchart illustrating an embodiment of an absorption type method of a thin film thickness measuring method.

Referring to FIG. 17, an absorption type method S2 of the thin film thickness measuring method in an embodiment may include measuring a first X-ray intensity of a bulk sample of the lower film disposed below the target thin film (operation S210), measuring second X-ray intensities of a plurality of lower films disposed below the target thin films with known thicknesses (operation S220), calculating calibration ratios, which are ratios of the second X-ray intensities to the first X-ray intensity, to generate the calibration curve or straight line indicating the variation of the calibration ratios against the thin film thickness (operation S230), and measuring a third X-ray intensity of the lower film disposed below the target thin film with an unknown thickness to derive the thin film thickness corresponding to the third X-ray intensity from the calibration curve or straight line (operation S240).

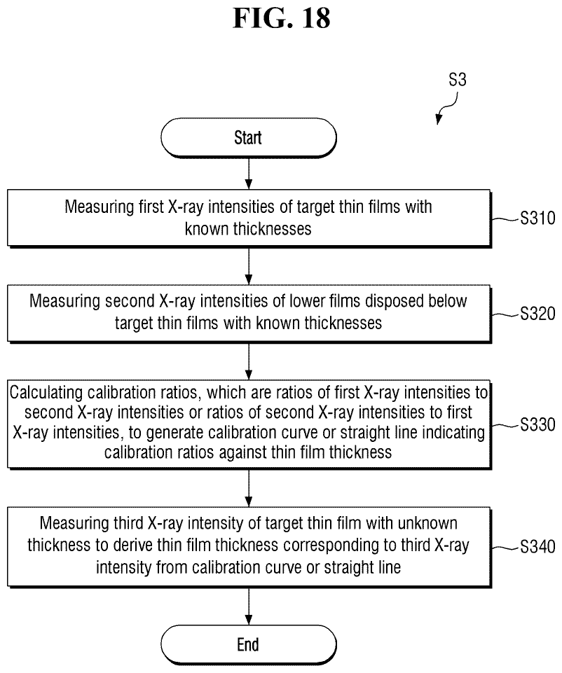

FIG. 18 is a flowchart illustrating an embodiment of an element ratio type method of a thin film thickness measuring method.

Referring to FIG. 18, an element ratio type method S3 of the thin film thickness measuring method in an embodiment may include measuring first X-ray intensities of the target thin films with known thicknesses (operation S310), measuring second X-ray intensities of the lower films disposed below the target thin films with known thicknesses (operation S320), calculating calibration ratios, which are ratios of the first X-ray intensities to the second X-ray intensities or ratios of the second X-ray intensities to the first X-ray intensities, to generate the calibration curve or straight line indicating the variation of the calibration ratios against the thin film thickness (operation S330), and measuring a third X-ray intensity of the target thin film with an unknown thickness to derive the thin film thickness corresponding to the third X-ray intensity from the calibration curve or straight line (operation S340).

In the drawing, it is illustrated that operation S320 is performed after operation S310, but the disclosure is not limited thereto. In an embodiment, operation S310 may be performed after operation S320. In another embodiment, operation S310 and operation S320 may be simultaneously performed.

The thin film thickness measuring method in an embodiment may select at least one of the emission type method S1, the absorption type method S2, or the element ratio type method S3 to measure the thin film thickness.

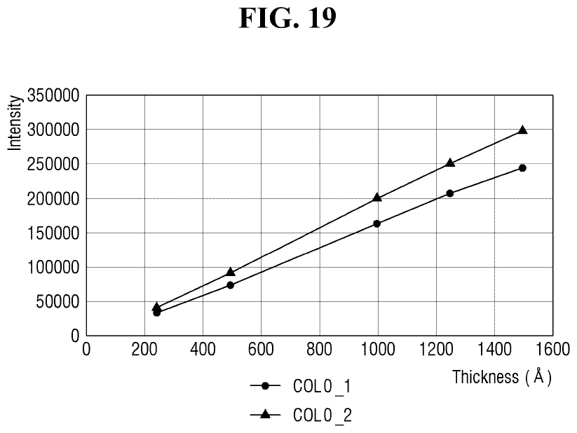

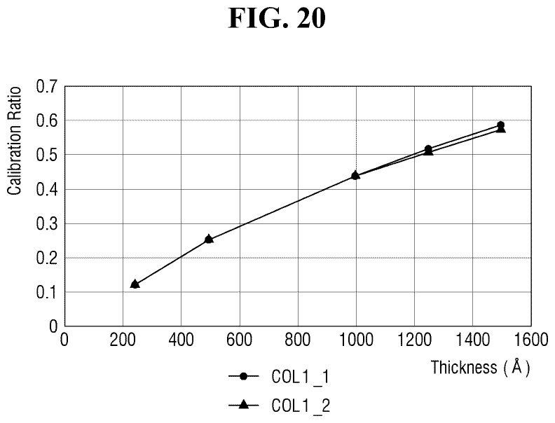

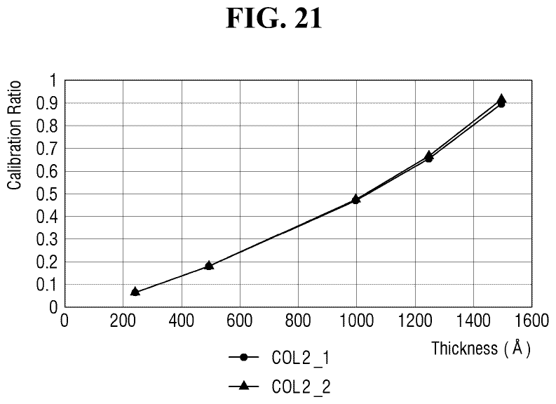

FIG. 19 illustrates an X-ray intensity measurement graph according to a comparative embodiment. FIG. 20 illustrates a calibration graph measured by an embodiment of an emission type method of a thin film thickness measuring method. FIG. 21 illustrates a calibration graph measured by an embodiment of an element ratio type method of a thin film thickness measuring method.

Referring to FIGS. 19 to 21 in addition to FIGS. 4, 5, 9, and 14, a first comparative graph COL0_1 and a second comparative graph COL0_2 shown in FIG. 19 are graphs obtained by measuring X-ray intensities generated from the same target object SBJ using different X-ray detectors 300. A first experimental graph COL1_1 and a second experimental graph COL1_2 shown in FIG. 20 are also graphs obtained by measuring X-ray intensities generated from the same target object SBJ using different X-ray detectors 300. A third experimental graph COL2_1 and a fourth experimental graph COL2_2 shown in FIG. 21 are also graphs obtained by measuring X-ray intensities generated from the same target object SBJ using different X-ray detectors 300.

The first comparative graph COL0_1 and the second comparative graph COL0_2 exhibit differences even though they are obtained by measuring the X-ray intensities for each thickness of the target thin film 20 of the same target object SBJ.

In an embodiment, the X-ray intensity generated from the target thin film 20 having the same thickness of 1000 Å is approximately 160,000 in the first comparative graph COL0_1 and approximately 200,000 in the second comparative graph COL0_2.

In another embodiment, the thickness of the target thin film 20 having the same X-ray intensity of 200,000 is approximately 1200 Å in the first comparative graph COL0_1 and approximately 1000 Å in the second comparative graph COL0_2.

In this way, when the X-ray intensity generated from the target thin film 20 is directly measured and used to generate the calibration graph, the data in the graph changes as the X-ray detector 300 changes.

Factors affecting X-ray intensity may include not only the acceleration voltage and the type of elements contained in the target object SBJ as described above, but also additional factors such as the sensitivity of the X-ray detector 300 or product functions.

By the calibration ratio as in the thin film thickness measuring device 1000 and the thin film thickness measuring method in the illustrated embodiment, the above different factors affecting the X-ray intensity may be controlled to cancel each other out or be equal, thereby minimizing a measurement error.

In an embodiment, FIG. 20 shows a calibration graph generated using the calibration ratio, which is a ratio of the X-ray intensity I_{m.20} of the measuring sample of the target thin film 20 to the X-ray intensity I_{b.20} of the bulk sample 20A of the target thin film 20. In other words, FIG. 20 is a calibration graph generated using the emission type method.

In another embodiment, FIG. 21 shows a calibration graph generated using the calibration ratio, which is a ratio of the X-ray intensity I_{m.20} of the measuring sample of the target thin film 20 to the X-ray intensity I_{m.10} of the measuring sample of the lower film 10. In other words, FIG. 21 is a calibration graph generated using the element ratio type method.

In this way, when the calibration graph is generated using the calibration ratio as in the emission type method, the absorption type method, and the element ratio type method, factors due to the X-ray detector 300 and other factors depending on the performance of the thin film thickness measuring device 1000 may be controlled to cancel each other out or be equal, thereby minimizing a measurement error.

In the thin film thickness measuring device 1000 and the thin film thickness measuring method in the illustrated embodiment, it is possible to measure the thickness of the thin film in a non-destructive and non-contact manner without damaging the target object SBJ. Therefore, it is possible to measure the thickness of an actual pattern of the display device DD (refer to FIG. 1) in actual mass production, and thus the accuracy of the thickness measurement may be improved.

In addition, in the thin film thickness measuring device 1000 and the thin film thickness measuring method in the illustrated embodiment, since it is performed in a non-destructive and non-contact manner, it is possible to continue a post-process after measuring the thickness of the display device DD (refer to FIG. 1) in actual mass production, thereby improving process yield and process efficiency.

In addition, the analyzable depth TH_M of the thin film thickness measuring device 1000 in the illustrated embodiment may be approximately a few nanometers to a few micrometers and have relatively high measurable resolution, so that the thickness of a fine pattern may be analyzed.

In concluding the detailed description, those skilled in the art will appreciate that many variations and modifications may be made to the preferred embodiments without substantially departing from the principles of the disclosure. Therefore, the disclosed preferred embodiments of the invention are used in a generic and descriptive sense only and not for purposes of limitation.

What is claimed is:

1. A thin film thickness measuring device comprising:
an electron beam generator which irradiates an electron beam onto a target object comprising a target thin film and a lower film disposed below the target thin film;
a detector which detects X-rays emitted from the target object by the electron beam; and
a calculation unit which derives a thickness of the target thin film from an intensity of the X-rays detected by the detector, the calculation unit comprising:
an X-ray intensity calculator which measures a first X-ray intensity of a bulk sample of the target thin film or a bulk sample of the lower film, measures second X-ray intensities of a plurality of target thin films for which thicknesses are known or a plurality of lower films disposed below the plurality of target thin films for which the thicknesses are known, and measures a third X-ray intensity of a target thin film for which a thickness is unknown or a lower film which is disposed below the target thin film for which the thickness is unknown;
a calibration ratio calculator which calculates calibration ratios which are ratios of the second X-ray intensities to the first X-ray intensity;
a calibration data storage which generates a calibration graph representing the calibration ratios against a thickness of the plurality of target thin films; and
a thickness calculator which derives a thin film thickness corresponding to the third X-ray intensity from the calibration graph.

2. The thin film thickness measuring device of claim 1, wherein the first X-ray intensity is an X-ray intensity of the bulk sample of the target thin film, and
the second X-ray intensities are X-ray intensities of the plurality of target thin films for which the thicknesses are known.

3. The thin film thickness measuring device of claim 1, wherein
the first X-ray intensity is an X-ray intensity of the bulk sample of the lower film, and
the second X-ray intensities are X-ray intensities of the plurality of lower films disposed below the plurality of target thin films for which the thicknesses are known.

4. The thin film thickness measuring device of claim 1, wherein
a calibration ratio when the first X-ray intensity is an X-ray intensity of the bulk sample of the target thin film, and the second X-ray intensities are X-ray intensities of the plurality of target thin films for which thicknesses are known is a first calibration ratio,
a calibration ratio when the first X-ray intensity is an X-ray intensity of the bulk sample of the lower film, and the second X-ray intensities are X-ray intensities of the plurality of lower films disposed below the plurality of target thin films for which the thicknesses are known is a second calibration ratio,
the first calibration ratio and the second calibration ratio are each less than or equal to 1, and
a sum of the first calibration ratio and the second calibration ratio measured from the plurality of target thin films for which the thicknesses are known and are identical to each other, is 1.

5. The thin film thickness measuring device of claim 1, wherein the calibration graph has a curved shape.

6. The thin film thickness measuring device of claim 5, wherein
the calibration graph having the curved shape has a linear segment in part, and
within the linear segment, the calibration graph having the curved shape has an error range of ±5% in comparison to a calibration graph having a straight line shape.

7. The thin film thickness measuring device of claim 6, wherein the calibration graph having the straight line shape is a graph obtained by connecting both end points of the linear segment by a straight line.

8. The thin film thickness measuring device of claim 7, wherein the linear segment is a range corresponding to 10% to 90% of a calibration ratio of the calibration ratios.

9. The thin film thickness measuring device of claim 8, wherein the thickness calculator derives a thickness of the target thin film using the calibration graph having the straight line shape within the linear segment.

10. The thin film thickness measuring device of claim 1, wherein a thickness of the plurality of target thin films for which the thicknesses are known is less than or equal to a thickness of the bulk sample of the target thin film.

11. The thin film thickness measuring device of claim 1, wherein a thickness of the bulk sample of the target thin film and a thickness of the bulk sample of the lower film are greater than or equal to an analyzable depth of the electron beam generator.

12. The thin film thickness measuring device of claim 1, wherein
the target thin film comprises a plurality of layers, and
the plurality of layers each includes at least one different element.

13. The thin film thickness measuring device of claim 1, wherein the target thin film comprises at least one of a metal layer of a single element, an alloy layer, or an oxide conductive layer.

14. The thin film thickness measuring device of claim 1, further comprising a stage on which the target object is disposed,
wherein the target object and the stage are not electrically connected.

15. The thin film thickness measuring device of claim 1, wherein the target object is a display device which is being manufactured or has been manufactured,
wherein the display device comprises:
at least one conductive film; and
a non-conductive film which insulates the at least one conductive film from an outside or other layers.

16. The thin film thickness measuring device of claim 15, wherein the target thin film is the conductive film, and the lower film is the non-conductive film.

17. A thin film thickness measuring device comprising:
an electron beam generator which irradiates an electron beam onto a target object comprising a target thin film and a lower film disposed below the target thin film;
a detector which detects X-rays emitted from the target object by the electron beam; and
a calculation unit which derives a thickness of the target thin film from an intensity of the X-rays detected by the detector, the calculation unit comprising:
an X-ray intensity calculator which measures first X-ray intensities of a plurality of target thin films for which thicknesses are known, measures second X-ray intensities of a plurality of lower films which are disposed below the plurality of target thin films for which the thicknesses are known, and measures a third X-ray intensity of a target thin film for which a thickness is unknown;
a calibration ratio calculator which calculates calibration ratios, which are ratios of the first X-ray intensities to the second X-ray intensities or ratios of the second X-ray intensities to the first X-ray intensities;
a calibration data storage which generates a calibration graph representing the calibration ratios against a thickness of the plurality of target thin films; and
a thickness calculator which derives a thin film thickness corresponding to the third X-ray intensity from the calibration graph.

18. The thin film thickness measuring device of claim 17, wherein the calibration graph has a straight line shape.

19. A thin film thickness measuring method comprising:
measuring a first X-ray intensity of a bulk sample of a target thin film or a bulk sample of a lower film disposed below the target thin film;
measuring second X-ray intensities of a plurality of target thin films for which thicknesses are known or a plurality of lower films which are disposed below the plurality of target thin films and for which thicknesses are known;
calculating calibration ratios, which are ratios of the second X-ray intensities to the first X-ray intensity, to generate a calibration graph representing the calibration ratios against a thickness of the plurality of target thin films; and
measuring a third X-ray intensity of a target thin film for which a thickness is unknown or a lower film which is disposed below the target thin film and for which a thickness is unknown to derive a thin film thickness corresponding to the third X-ray intensity from the calibration graph.

20. A thin film thickness measuring method comprising:
measuring first X-ray intensities of a plurality of target thin films for which thicknesses are known;
measuring second X-ray intensities of a plurality of lower films which are disposed below the plurality of target thin films and for which thicknesses are known;
calculating calibration ratios, which are ratios of the first X-ray intensities to the second X-ray intensities or ratios of the second X-ray intensities to the first X-ray intensities, to generate a calibration graph representing the calibration ratios against a thickness of the plurality of target thin films; and
measuring a third X-ray intensity of a target thin film for which a thickness is unknown to derive a thin film thickness corresponding to the third X-ray intensity from the calibration graph.
